(19) United States
(12) Patent Application Publication
(10) Pub. No.: US 2017/0208746 A1
(43) Pub. Date: Jul. 27, 2017

(54) METHOD AND SYSTEM FOR PREPARING AND PRODUCING PEANUT SPROUTS

(71) Applicant: JAMES KO, KILLEEN, TX (US)

(72) Inventor: JAMES KO, KILLEEN, TX (US)

(21) Appl. No.: 15/005,216

(22) Filed: Jan. 25, 2016

(51) Int. Cl. A01G 1/00; A01G 9/24; A01G 9/26

(52) U.S. Cl. CPC A01G 1/001; A01G 9/26; A01G 9/246

(57) ABSTRACT

Method of preparing and producing high-protein peanut sprouts is disclosed. A system to produce peanut sprouts is also disclosed.

### BACKGROUND OF THE INVENTION

1. Field of the invention

The present invention, in some embodiments thereof, relates to pomegranate sprouts and preparations derived therefrom and, more particularly, but not exclusively, to the use of same.

More particularly, this invention relates to a creation of balancing relationship between the sources of the heat, specially constructed winter ventilation inner cover, ventilation, ability to use the subject of invention at remote apiaries without permanent sources of electrical power.

2. Background Art

Peanut sprout is widely cultivated around the world and edible parts thereof have been used extensively in nutritious supplements as well as in the food industry. In the functional food industry, the peanut is included in nutritious category with an exceptional nutrient richness and antioxidant quality along with an appealing taste. Peanuts are a rich source of protein, crude fibers, mostly good fats, and essential vitamins.

Recent medical research suggests that high fat/lipid foodstuff and diets, particularly those high in cholesterol, saturated fatty acids and triglycerides, can contribute significantly to the development of many diseases, particularly heart diseases, atherosclerosis, high blood pressure and other cardiovascular diseases. In addition, obesity, often mentioned as endemic disease in many countries of the world, is also one of the risk factors of the above diseases.

A convenient food with high nutritional value and good health-care performance is provided to a consumer, and a novel technology is provided to high-valued germination of peanut sprouts; and the content of protein in the peanut sprout prepared by the method is high while the fat content is low.

### SUMMARY OF THE INVENTION

According to an aspect of some embodiments of the present invention there is provided a peanut sprout preparation. According to an aspect of some embodiments of the present invention there is provided a method of producing peanut sprouts, the method comprising: (a) germinating peanuts in water until sprout emergence; (b) moisturizing the sprouts without exposure of light so as to obtain light-unexposed sprouts; (c) incubating the light-unexposed sprouts in the dark; (d) watering the light-unexposed sprouts for a period of time, and (d) harvesting the peanut sprouts, thereby producing the peanut sprouts.

According to some embodiments of the invention, step (a) of the method is effected for about 2 to 3 days, wherein step (b) is effected for about 80 to 90 percent, wherein step (c) is effected for about 7 to 8 days, wherein (d) is effected for about every 2 to 3 hours during the step (c).

According to some embodiments of the invention, the food or feed product is selected from the group consisting of a dried sprout, a fresh sprout, a frozen sprout, a baked sprout, a stewed sprout, a fried sprout, an extruded sprout, a mashed sprout, a marinated sprout and a pickled sprout. Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

The present invention also involves a system for controlling climate and moisture of a housing. The system comprises at least a condition control sensor being adapted to sense temperature and humidity condition in the housing. The system further comprises ventilations fan being adapted to generate an air flow in the system and a heating element to preheat the air flow from outside. The system, in addition, comprises electronics connected to the condition control sensor, the ventilation fans, and the heating element. The electronics controls the ventilation fans and the heating element according to the sensed temperature and humidity condition in the housing.

In one embodiment of the invention, the system comprises a first fan, which is arranged in an air ventilation box and running continuously to create negative pressure inside the housing. Hence, the air flow generated by the first fan is more efficiently directed upwardly to the top of the system. The air flow generated by the first fan would have tendency to flow vertically.

According to a preferred embodiment, the system is further provided with a ventilation inner cover, which is adapted to let air pass through. The cover prevents dirt and flies from entering the housing. Especially, when the fan is activated, the generated air flow may drive dirt or flies towards the system rather than moisture saturated air only.

Further, according to an even more preferred embodiment, the ventilation inner cover comprises a board with holes, a net and/or a mesh-like structure.

In a preferred embodiment, the climate and moisture control system further comprises a second fan adapted to generate an air flow in at least a portion of the housing, wherein the second fan is connected to the electronics, and the electronics controls the second fan according to the sensed humidity and temperature condition.

This provides a second source for an air flow in the system. This allows for a more favorable distribution of the air flow in the housing. Moreover, the overall airflow may be increased by using two fans. It is even more preferred that the second fan is arranged in a top section of the housing.

In some embodiments, the first and second fan may have an operating voltage of 9-12 V DC. Moreover, the first and second fan and the electronics may further comprise means for converting supplied electrical power, e.g., the electronics may comprise a converter that is adapted to convert any of a 110 V and a 220V AC supply voltage to 9-12 V DC, which is then used to power the electronics and the first and second fan. The converting means may automatically detect the supply voltage and convert it accordingly.

In another preferred embodiment, the condition control sensor further comprises at least one humidity sensor and at least one temperature sensor, and the electronics activates the second fan if the sensed humidity is above an upper humidity threshold.

Additionally or alternatively, the electronics deactivates the first fan if the sensed humidity is below a lower humidity threshold.

These embodiments prevent the humidity in the housing from rising above a given value. When the fan is deactivated, the air flow stops and the air exchange in the housing is minimized, and thus allows moisture building up inside the housing.

In particular, the upper humidity threshold is between 80% and 90%, preferably between 83% and 85% and most preferably between 80% and 83% relative humidity. These upper humidity threshold values have been experienced to provide a good condition for the sprouts to grow.

The electronics may further comprise any type of analog and digital or mixed-signal electronics. The electronics may further comprise at least one analog-to-digital converter for converting signals received from the condition control sensor.

According to a preferred embodiment, the system further comprises one or more ventilation openings. Providing one or more ventilation openings has the benefit of allowing air exchange between the inside and the outside of the housing other than through the ventilation openings. Fresh air may be expelled out of the housing to affect the temperature and humidity inside the housing.

Moreover, in some embodiments, the system may comprise more than two fans to provide a more detailed control of the air flow in the housing. The fans are connected to and controlled by the electronics.

In a preferred embodiment, the system further comprises removable racks being arranged in the housing for harvesting the sprouts.

The electronics controls the second fan according to the sensed humidity and temperature condition. The electronics increases the voltage to 240 V applied to the heating element if the sensed humidity is above an upper humidity threshold.

Using both ways of heat transfer such as heat convection and heat radiation of heat energy, produced by heating film, to transfer to the cluster increase efficiency of the heating element, comfort ability for bees inside chamber during cold prolonged winter season.

When the main electrical power source is disconnected, the ventilation fans can be connected to the automobile battery power or “solar panel” to keep the system running. The two ventilation fans together can use 0.048 A of DC or 0.58 Watt of energy that an automobile battery can be used without battery recharge. Solar panels as a potential electrical power source can definitely also be used as a secondary electrical power source.

### BRIEF DESCRIPTION OF DRAWINGS

FIG. 1 is a flowchart describing a method for preparing and producing peanut sprouts using the system of FIG. 2.

FIG. 2 shows a perspective view of the ventilation fans located in the top section of the embodiment of the present invention.

FIG. 3 shows a cross-sectional view of the beehive according to the embodiment of the present invention.

FIG. 4 shows a perspective view of the beehive heater installed in the bottom panel of the embodiment of the present invention.

FIG. 5 shows an electrical control diagram to be used for the embodiment of the present invention.

### DETAILED DESCRIPTION OF THE INVENTION

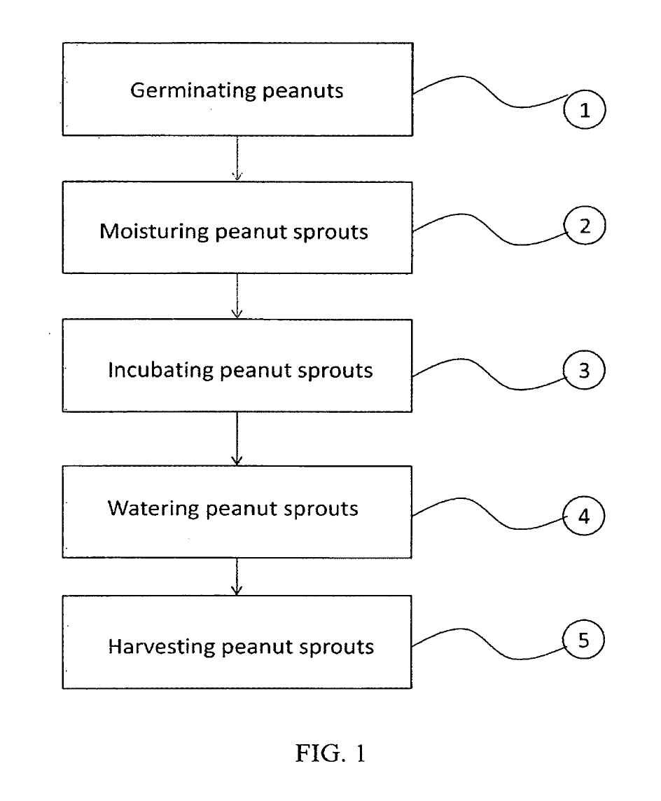

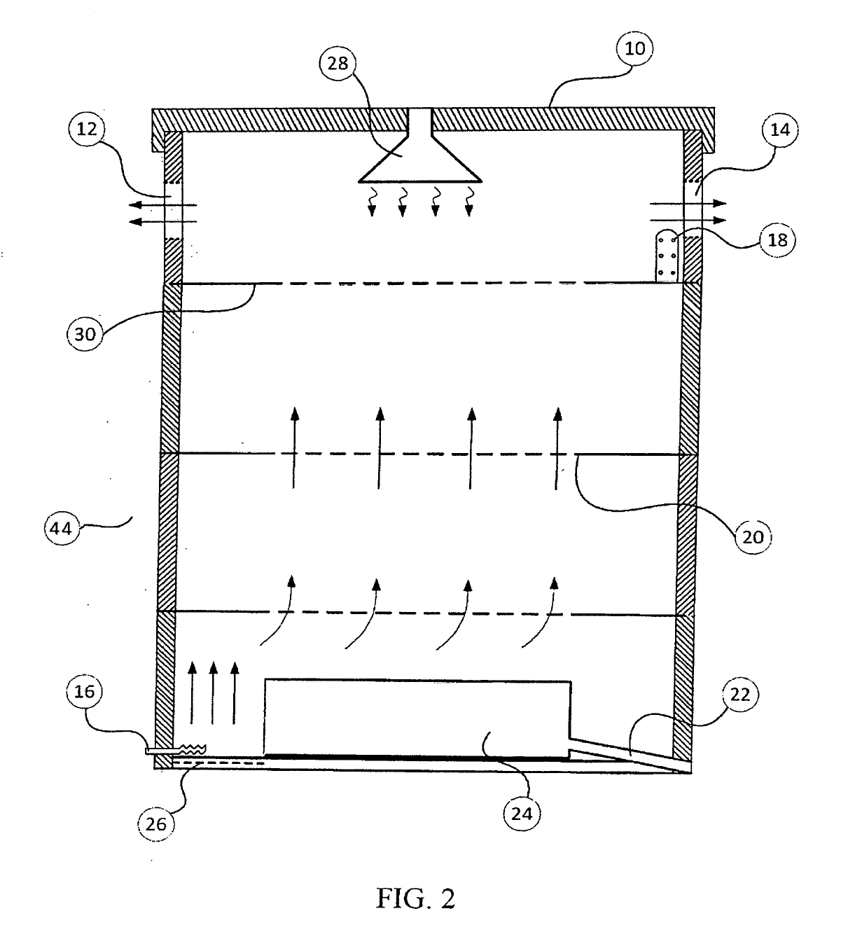

Referring to FIG. 1, and with reference to the system 44 of FIG. 2, illustrates an exemplary method by which the sprouts are prepared and produced from peanuts.

The present method begins with step 1, wherein raw peanuts are dried and removed hard shells but left reddish skins on. Still in step 1, the reddish skinned peanuts are soaked in tap water for about 2 to 3 days to sprout.

At step 2, sprouted peanuts are stored in a storage room and kept out sun light, wherein the sprouted peanuts will be moisturized for about 1 to 2 hours.

At step 3, the moisturized sprouted peanuts are incubated for about 85% to 90% humidity.

At step 4, sprouted peanuts are sprinkled for about every 2 to 3 hours continuously.

At step 5, the sprouted peanuts are harvested.

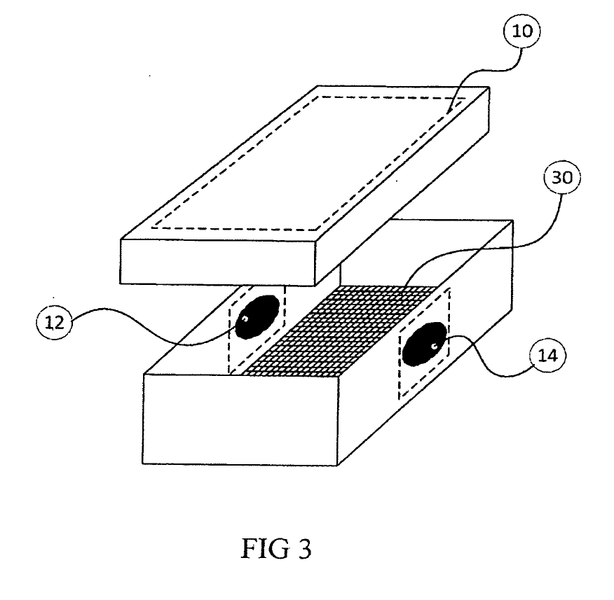

FIG. 2 to FIG. 5 describes an embodiment of the present invention comprising a system for monitoring and controlling climate and moisture in a housing 44. An assembly of top section where ventilation fans are located according to the embodiment of the present invention will be described with reference to FIG. 3.

Referring FIG. 2 and FIG. 3, the standard parts of the housing 44 assembly includes an outer cover 10 to be a put on top of an air ventilation box 42 where a first ventilation fan 12 and a second ventilation 14 are adapted to generate an air flow from the housing to the air ventilation box, and wherein water sprinkler 28 is installed to allow watering the sprouted peanuts. In the embodiment shown on FIG. 3, the air ventilation box 42 is open on a bottom side. The assembly further includes an air ventilation inner cover 30 which is mounted near the lower edge of the air ventilation box 42.

Still referring FIG. 2, the air ventilation inner cover 30 comprises a plurality of rectangle holes covered by wire mesh to allow the air passing through. The holes will also lead the air flow being generated by the first ventilation fan 12 and the second ventilation 14 out of the housing 44. In the center of the air ventilation cover 10, there is a foam insulation which is mounted upward to the bottom to prevent condensation on the inner surface.

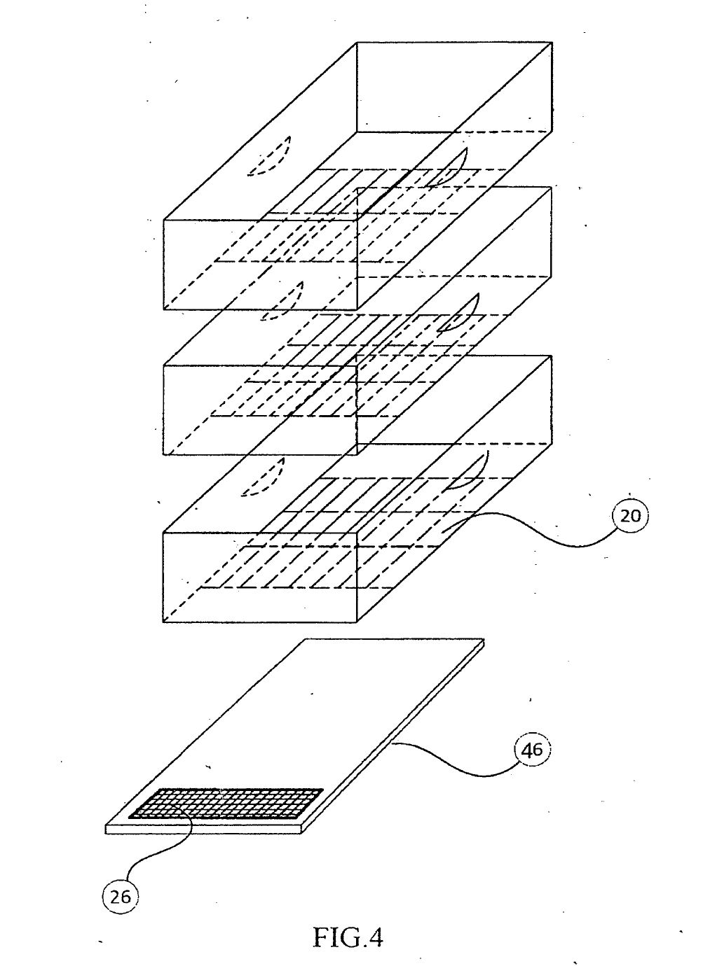

Referring to FIGS. 2 and 4, the housing 44 comprises wire trays 20, a bottom board 46, in which is mounted heating element 16. Heating element 16 is inserted above the bottom board 46 and a lower air flow entrance 26. The bottom board 46 projects beyond the front of the lower air flow entrance 26 to allow the air passing through.

FIG. 2 also shows the air flow pattern within the housing 44. The air will flow out of the housing 44 through the first ventilation fan 12 and the second ventilation 14, when the system is in operation in response to the condition control sensor 18. The air flow through the entrance 26 in the bottom board 46 is heated by the heating element 16 and passing upwardly through the sprout trays 20 and through the holes of the air ventilation inner cover 30 out of the housing 44.

In the embodiment shown in FIG. 2, the housing 44 also comprises wire trays 20. When installed, the wire trays 20 are spaced apart to provide extra space for the sprouts growth and air flow between each tray.

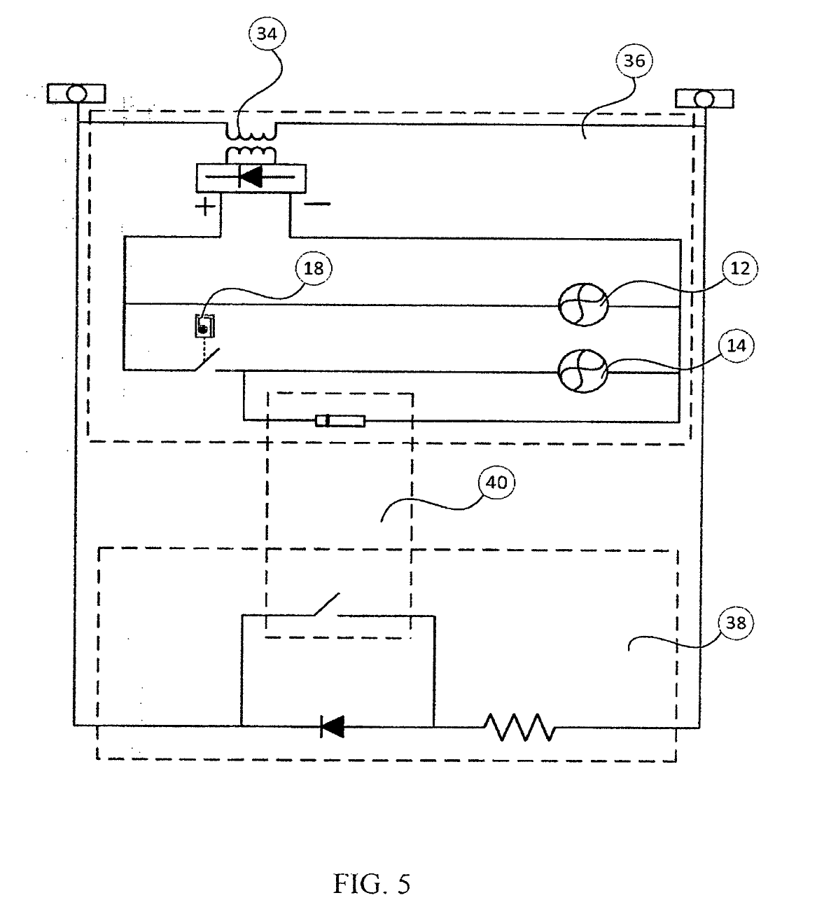

With reference to FIGS. 2 and 5, the housing 44 further comprises electronics 36 to control the first ventilation fan 12 and the second ventilation fan 14. The electronics 36 switches on the first fan 12 and heating element 18 to run continuously in order to generate a negative air flow pressure within the housing 44. The electronics 36 is, moreover, connected to a condition control sensor 18, which takes the form of a dual sensor for, both, temperature and humidity. The condition control sensor 18 is arranged on the side of the housing 44. The electronics 36 controls the second fan 14 according to signals from the condition control sensor 18.

Returning to FIG. 5, in some embodiments, the electronics 36 controlling the second fan 14 may comprise complete activation or deactivation of the second fan 14. In these embodiments, the second fan 14 either runs on a maximum power or is complete switched off, based on the sensed condition sensor 18, to increase the negative air flow pressure out of the housing 44. The second fan 14 is activated if the sensed humidity and temperature are above the upper humidity thresholds. However, the second fan 14 is deactivated if the sensed humidity and temperature are below the lower humidity and temperature thresholds. For example, the electronics 36 may switch on the second fan 14 if the sensed temperature is above 35° C. and the sensed humidity is above 90% and switch off the second fan 14 if the sensed humidity is below 80%. In all other cases, the electronics 36 does not change the previous powering stage of the second fan 14.

Moreover, in some embodiments, the climate and moisture control system may include more than two fans to provide a more detailed control of the air flow in the beehive enclosure. The fans are connected and controlled by the electronics 36.

Still in FIGS. 2 and 5, in other embodiments, electronics 38 may control the heating element 16 to switch to intermediate power values larger than 120 V and lower than 240 V, based on the sensed condition sensor 18. Here, both continuous and discontinuous power values may be used.

Having illustrated and described the principles of the present invention in a preferred embodiment, it will be apparent to those skilled in the art that the embodiment can be modified in arrangement and detail without departing from such principles. Any and all such embodiments are intended to be included within the scope of the following claims.

What is claimed is:

1. A method of producing peanut sprouts comprising the following steps:
(a) germinating peanuts in the dark until cotyledon emergence wherein said germinating is effected for 2 to 3 days;
(b) moisturizing said cotyledons without light for 1 hour to 2 hours so as to obtain light-unexposed sprouts;
(c) incubating said light-unexposed sprouts in the dark for 7 to 8 days;
(d) watering said light-unexposed sprouts every 2 to 3 hours; and
(e) harvesting said peanut sprouts, thereby producing the peanut sprouts.

2. A system using the method of claim 1 to produce peanut sprouts comprising:
(a) at least one condition control sensor being adapted to sense humidity and temperature inside a housing,
(b) a first ventilation fan being adapted to generate an air flow out of the housing,
(c) a second ventilation fan being adapted to generate an air flow out of the housing,
(d) a ventilation circuit connected to the condition control sensor and the ventilation fan,
(e) a heating means being mounted in a bottom panel,
(f) a heating circuit connected to the heating means,
(g) a plenum system having air inlet means and outlet means.

3. The system of claim 2, wherein the condition control sensor further comprising at least one temperature sensor and at least one humidity sensor to sense temperature and air humidity condition inside the housing, wherein the sensed condition corresponds to an averaged humidity and temperature sensed by the temperature sensor and the humidity sensor.

4. The system of claim 2, wherein the ventilation circuit activates or deactivates the first ventilation fan automatically.

5. The system of claim 2 further comprising at least a second ventilation fan adapted to generate an air flow out of the housing, wherein the second ventilation fan is connected to the condition control sensor.

6. The system of claim 5, wherein the second ventilation fan is connected to the ventilation circuit and the ventilation circuit further controls the second ventilation fan according to the sensed temperature and the sensed humidity of the housing.

7. The system of claim 6, wherein the ventilation circuit activates the second ventilation fan if the sensed temperature and the sensed humidity is above the highest humidity threshold.

8. The system of claim 6, wherein the ventilation circuit deactivates the second ventilation fan if the sensed temperature and the sensed humidity is below the lowest humidity threshold.

9. The system of claim 2, wherein the ventilation circuit further comprising an electrical transformer to reduce voltage into the ventilation fan.

10. The system of claim 2, wherein the heating means is a laminated carbon heating film or any type of electrical resistance element.

11. The system of claim 2, wherein the heating means is connected to the heating circuit and the heating circuit further controls the heating means according to the sensed temperature and the sensed humidity of the housing.

12. The system of claim 2, wherein the heating circuit further comprising a solid state relay circuit to increase the voltage into the heating elements.

13. The system of claim 12, wherein the heating circuit activates the solid state relay circuit if the sensed temperature and the sensed humidity is above the highest humidity threshold.

14. The system of claim 12, wherein the heating circuit deactivates the solid state relay circuit if the sensed temperature and the sensed humidity is below the lowest humidity threshold.

15. The system of claim 2, wherein the air inlet means comprises passages through the bottom panel to distribute inflowing air throughout the housing.

16. The system of claim 15, wherein the inflowing air is heated to said preselected temperature by the heating means.

17. The system of claim 16, wherein the heated air flows upwardly out of the housing through a ventilated air current forming outlet means to reduce the sensed humidity.

18. The system of claim 2 further comprising powering means being connected to the ventilation circuit, the first ventilation fan, the second ventilation fan, and the heating means, wherein the powering means comprises at least electrical power source.
